(19) United States
(12) Patent Application Publication
(10) Pub. No.: US 2003/0042850 A1
(43) Pub. Date: Mar. 6, 2003

(54) Electroluminescent device comprising quantum dots

(76) Inventors: Dietrich Bertram, Aachen (DE); Klemens Brunner, Eindhoven (NL); Johannes Willem Hofstraat, Eindhoven (NL); Hans Nikol, St. Michelsgestel (NL)

Correspondence Address: U.S. Philips Corporation, 580 White Plains Road, Tarrytown, NY, 10591, US

(21) Appl. No.: 10/233,459

(22) Filed: Sep. 3, 2002

(30) Foreign Application Priority Data
Sep. 4, 2001 (EP) 01121146.3

(51) Int. Cl. H05B 33/14

(52) U.S. Cl. 313/504

(57) ABSTRACT

The invention describes an electroluminescent device wherein the device is characterized by a light emitting layer (3) comprising quantum dots. The quantum dots are provided with capping molecules with functional units on the quantum dot surfaces which cause excited state injection into the quantum dots. The capping molecules with functional units comprise electron transport moieties and/or hole transport moieties and/or exciton transport moieties, which cause the injection of electrons, holes, and excitons, respectively, to the core of the quantum dots.

The present invention relates to an electroluminescent device comprising quantum dots.

Electroluminescent devices, in particular light emitting diodes (LEDs), are ubiquitous to modem display technology. More than 30 billion chips are produced each year and new applications, such as automobile lights and traffic signals, continue to grow. Conventional diodes are made from inorganic compound semiconductors, typically AlGaAs (red), AlGaInP (orange-yellow-green). and AlGaInN (green-blue). These diodes emit monochromatic light of a frequency corresponding to the band gap of the compound semiconductor used in the device. Thus, conventional LEDs cannot emit white light, or indeed, light of any “mixed” color, which is composed of a mixture of frequencies. Further, producing a LED even of a particular desired “pure” single-frequency color can be difficult, since excellent control of semiconductor chemistry is required.

It has also been proposed to manufacture white or colored LEDs by combining various derivatives of photoluminescent polymers such as poly(phenylene vinylene) (PPVs). One device which has been proposed involves a PPV coating over a blue GaN LED, where the light from the LED stimulates emission in the characteristic color of the PPV, so that the observed light is composed of a mixture of the characteristic colors of the LED and the PPV. However, the maximum theoretical quantum yield for PPV-based devices is 25%, and the color control is often poor, since organic materials tend to fluoresce in rather wide spectra. Furthermore, PPVs are rather difficult to manufacture reliably, since they are degraded by light, oxygen, and water.

It has also been proposed to produce electroluminescent devices of varying colors by the use of quantum dots. Quantum dots are semiconductor nanocrystallites whose radii are smaller than the bulk exciton Bohr radius. It has been found that the wavelength of the light emitted by such a device is dependent on the size of the quantum dots. Such a device is known from U.S. Pat No. 5,537,000.

In order to improve the photoluminescent properties of the quantum dots, the quantum dot surface has been paasivated by reaction of the surface atoms of the quantum dot with organic moieties such as tri-n-octyl phosphine oxide (TOPO). CdSe quantum dots capped with organic moieties exhibit photoluminescent quantum yields of around 5 to 10% (Bawendi et al., J Am. Chem. Soc., 1993, 115, 8706). In WO 99/26299 quantum dots are described consisting of core comprising CdX, where X=S, Se, Te, and an overcoating of ZnY, where Y=S, Se, uniformly deposited thereon. Such quantum dots show photoluminescent quantum yields ranging from 30 to 50%.

It is one object of the invention to provide an electroluminescent device comprising improved quantum dots.

According to the invention, this object is achieved by means of an electroluminescent device comprising:

a) hole processing means capable of injecting and transporting holes;

b) a light emitting layer in contact with said hole processing means comprising quantum dots, each of said quantum dots being provided with at least one capping molecule with functional unit on the quantum dot surface which causes excited state injection into the quantum dot; and

c) electron processing means in contact with said light emitting layer for injecting and transporting electrons into said light emitting layer.

One advantage of such a device is that recombination of the electrons and holes takes place inside the quantum dots. This process, and thus the electroluminescent quantum yield of the whole device, can be improved by the capping molecules with functional units being present on the quantum dot surfaces. The capping molecules with functional units cause the injection of excited states such as electrons, holes or excitons into the quantum dots.

The improvement according to claim 3 has the advantage that an electron and/or a hole is conducted from the surface of the quantum dot to the core of the quantum dot where it can recombine with the respective counter part. An exciton transport moiety conducts an exciton from the surface of the quantum dot to core of the quantum dot where the electron and the hole finally recombine. The electron transport moieties, the hole transport moieties and the exciton transport moieties function as some kind of antennas which direct and transport electrons, holes and excitons to the cores of the quantum dots.

The hole transport moieties mentioned in claim 4 and the electron transport moieties mentioned in claim 5 are effective charge conductors. The exciton transport moieties mentioned in claim 6 are effective exciton conductors.

With one of the coupling units mentioned in claim 7, a capping molecule with functional unit is effectively coupled to the surface of a quantum dot.

According to claim 8, stability of a quantum dot can be increased by linking passivating molecules to its surface. Claim 9 mentions effective passivating molecules.

Furthermore the invention relates to a quantum dot provided with at least one capping molecule with functional unit on the quantum dot surface which causes excited state injection into the quantum dot.

The invention will be explained in more detail with reference to the drawings, in which

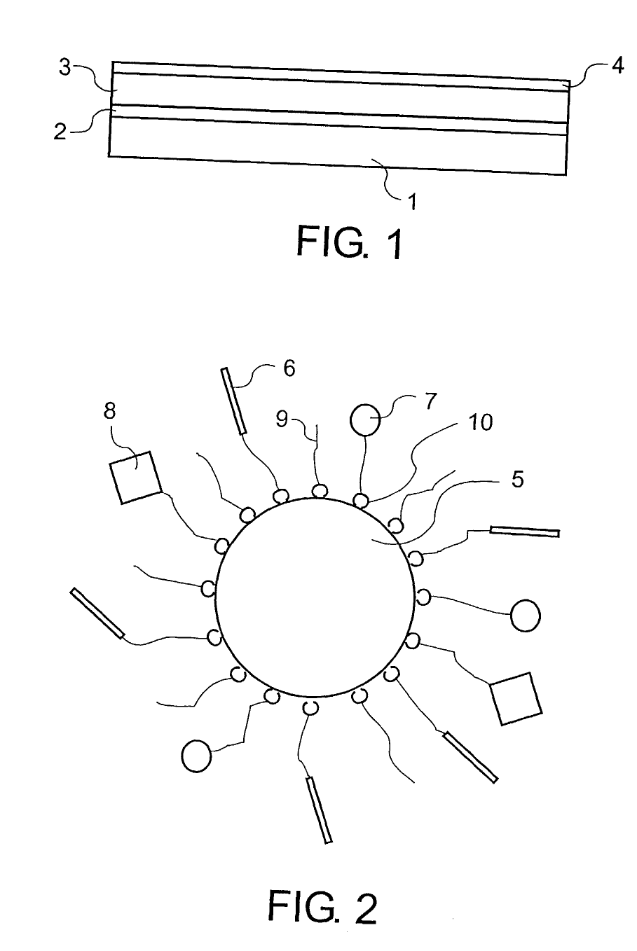

FIG. 1 shows a schematic illustration of the electroluminescent device of the invention

FIG. 2 schematic cross-section of a quantum dot comprising different capping molecules.

An electroluminescent device as shown in FIG. 1 comprises a substrate 1, such as a transparent glass plate. A hole processing means 2 is placed on top of the substrate 1. The hole processing means 2 includes the capability of hole injection as well as hole transport. The hole processing means 2 may comprise one layer which has the capability of hole injection and hole transport or two layers whereof one has the capability of hole injection and the other has the capability of hole transport. A hole processing means 2 consisting of a single layer may comprise P-doped silicon, indium tin oxide or fluoride doped tin oxide. If hole processing means 2 comprises two layers, the hole injection layer which is placed on top of the substrate 1 may comprise indium tin oxide, tin oxide, fluoride doped tin oxide, silver, gold, copper or p-type semiconductors having a band gap greater than 3 eV. The hole transport layer which is formed over the hole injection layer comprises a material capable of transporting injected holes through the hole transporting layer toward light emitting layer 3. Materials which may be used in the construction of a hole transport layer include conductive polymers such as poly(phenylene vinylene) (PPVs) or polythiophenes, e.g. polyethylene dioxythiophene. Also p-type semiconductors having a band gap greater than 3 eV may be used in the construction of a hole transport layer.

Light emitting layer 3 is formed over hole processing means 2. Light emitting layer 3 comprises quantum dots. Quantum dots are semiconductor nanometer crystals and may comprise Group II-VI semiconductor compounds such as MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe and HgTe; and/or crystals of Group III-V semiconductor compounds such as GaAs, GaP, InN, InAs, InP and InSb; and/or crystals of group IV semiconductor compounds such as Si and Ge. In addition, the semiconductor compounds may be doped with rare earth metal cations or transition metal cations such as Eu³⁺, Tb³⁺, Ag⁺ or Cu⁺. It may be possible that a quantum dot consists of two ore more semiconductor compounds. The quantum dots are preferably prepared by wet chemical processes. Most likely the quantum dots comprise InN, InGaP or GaAs. The radii of the quantum dots are smaller than the exciton Bohr radius of the respective bulk material. Most likely the quantum dots have radii no larger than about 10 nm. It is most preferable that the quantum dots have radii between 1 and 6 nm.

It is possible that the quantum dots comprise a core-shell structure. In this case, a quantum dot consists of light emitting core material, e.g. CdSe overcoated with a shell material of higher bandgap, e.g. ZnS, such that an electron and/or a hole and/or an exciton is confined to the core of the quantum dot.

The surfaces of the quantum dots are provided with capping molecules. In order to cause excited state injection into the quantum dots the capping molecules comprising functional units are linked to the surfaces of the quantum dots. An excited state may be a hole, an electron or an exciton. In order to cause hole injection into a quantum dot, at least one capping molecule comprising a hole transport moiety as functional unit is linked to the surface of a quantum dot. A hole transport moiety may comprise a tertiary aromatic amine, a thiophene oligomer, a thiophene polymer, a pyrrol oligomer, a pyrrol polymer, a phenylenevinylene oligomer, a phenylenevinylene polymer, a vinylcarbazol oligomer, a vinylcarbazol polymer, a fluorene oligomer, a fluorene polymer, a phenylenethyne oligomer, a phenylenethyne polymer, a phenylene oligomer, a phenylene polymer, an acetylene oligomer, an acetylene polymer, a phthalocyanine, a phthalocyanine derivative, a porphyrine or a porphyrine derivative One or more carbon atoms of the oligomers or polymers may also be substituted. Preferably such a capping molecule with functional unit comprises a triphenyl amine unit, a phenylenevinylene oligomer unit, a phenylene oligomer unit or a fluorene oligomer unit. In addition, dyes having the highest occupied molecular orbital (HOMO) within the range of about four and about six eV can be used as hole transport moieties.

In order to cause electron injection into the quantum dots, at least one capping molecule comprising an electron transport moiety as functional unit is linked to the surface of the quantum dot. An electron transport moiety may comprise an oxadiazole, an oxadiazole derivative, an oxazole, an oxazole derivative, an isoxazole, an isoxazole derivative, a thiazole, a thiazole derivative, an isothiazole, an isothiazole derivative, a thiadiazole, a thiadiazole derivative, a 1,2,3 triazole, a 1,2,3 triazole derivative, a 1,3,5 triazine, a 1,3,5 triazine derivative, a quinoxaline, a quinoxaline derivative, a pyrrol oligomer, a pyrrol polymer, a phenylenevinylene oligomer, a phenylenevinylene polymer, a vinylcarbazol oligomer, a vinylcarbazol polymer, a fluorene oligomer, a fluorene polymer, a phenylenethyne oligomer, a phenylenethyne polymer, a phenylene oligomer, a phenylene polymer, a thiophene oligomer, a thiophene polymer, an acetylene polymer or an acetylene oligomer. One or more carbon atoms of the oligomers or polymers may also be substituted. Preferably such a capping molecule with functional unit comprises an oxadiazole unit, a 1,2,3 triazol unit or a fluorene unit.

In order to cause exciton injection into a quantum dot, at least one capping molecule comprising an exciton transport moiety as functional unit is linked to the surface of the quantum dot. An exciton transport moiety may comprise a fluorene oligomer, a fluorene polymer, a phenylenevinylene oligomer, a phenylenevinylene polymer, a perylene, a perylene derivative, a coumarine, a coumarine derivative, a phenoxazone, a phenoxazone derivative, a 9,9′ spirobifluorene oligomer, a 9,9′ spirobifluorene polymer, a phenylene polymer, a phenylene oligomer, 4-dicyanmethylene-2-methyl-6-(p-dimethylaminostyryl)-4H-pyran (DCM), a 4-dicyanmethylene-2-methyl-6-(p-dimethylaminostyryl)-4H-pyran derivative, a rhodamine, a rhodamine derivative, an oxazine, an oxazine derivative, an oxazole, an oxazole derivative, a styryl, a styryl derivative, a metal-organic complex, a stilbene, a stilbene derivative, a flavin, a flavin derivative, a fluorescein, a fluorescein derivative, a pyrromethene, a pyrromethene derivatives or any other dye. One or more carbon atoms of the oligomers or polymers may also be substituted. Preferably such a capping molecule with functional unit comprises a phenoxazone unit or a 4-dicyanmethylene-2-methl-6-(p-dimethylaminostyryl)-4H-pyran unit.

In order to stabilize the quantum dots, e.g. to prevent agglomeration, passivating molecules may be also linked to the surfaces of the quantum dots. Such passivating molecules may comprise fluoride ions, molecules comprising a non-aromatic hydrocarbon moiety, coordinating solvents, phosphanes or phosphane oxides. Most likely the surfaces of the quantum dots are passivated with fluoride ions.

A capping molecule with functional unit or a molecule comprising a non-aromatic hydrocarbon moiety is linked to the surface of a quantum dot via a coupling unit. Such a coupling unit comprises a group which may be selected from the group of thiols, sulfates, sulfites, sulfides, carboxylic acids, aldehydes, alcohols, esters, phosphines, phosphates, amines and non-fused polynuclear pyridines. Most preferable is the use of a thiol group as coupling unit.

In addition, such a capping molecule with functional unit may comprise a spacer unit which interconnects coupling unit and functional unit. The spacer unit may comprise an organic moiety such as straight, branched, or cyclic hydrocarbon chain containing between about one and twenty carbon atoms, more preferably between about one and about ten carbon atoms. One or more carbon atoms of the hydrocarbon chain may also be substituted. The hydrocarbon chain may further include one or more degrees of unsaturation, i.e. one or more double or triple bonds. Alternatively a spacer unit may comprise a cyclic aromatic hydrocarbon chain containing between about six to about twenty carbon atoms. One or more carbon atoms of the cyclic aromatic hydrocarbon chain may also be substituted.

The quantum dots are embedded in a matrix. The matrix may comprise an organic material, most likely a polymeric organic material such as polyimide. The material may also comprise an inorganic material such as ZnS.

An electron processing means 4 is placed on top of light emitting layer 3. The electron processing means 4 includes the capability of electron injection as well as electron transport. The electron processing means 4 may comprise one layer which has the capability of electron injection and electron transport or two layers whereof one has the capability of electron injection and the other has the capability of electron transport. A electron processing means 4 consisting of a single layer may comprise indium doped tin oxide, fluoride doped tin oxide, any metal or N-doped semiconductor.

If electron processing means 4 comprises two layers, the electron transport layer which is placed on top of the light emitting layer 3 may comprise a material capable of transporting injected electrons through the electron transporting layer toward light emitting layer 3. Materials which may be used in the construction of a electron transport layer include conductive polymers such as polypyrrols, polyfluorenes, phenylenevinylene polymers, or polythiophenes.

The electron injection layer may comprise any metal or N-doped semiconductor layer capable of injecting electrons into the previously described electron transport layer. The electron injecting layer needs not to be transparent. It may be advantageous that the electron injection layer is reflective so that the visible light emitted by light emitting layer 3 upon recombination of the holes and the electrons in the device, will be reflected back through the transparent layers to be viewable by one observing the electroluminescent device from the hole processing side of the device, e.g. through a transparent glass substrate serving as substrate 1. Finally the whole device is sealed after assembly with an encapsulating material such as an epoxy resin, Si₃N₄ or amorphous carbon.

It is also possible that the electroluminescent device shows an inverse construction. In this construction electron processing means 4 is placed on top of substrate 1, light emitting layer 3 is placed on top of electron processing means 4 and hole processing means 2 is placed on top of light emitting layer 3.

FIG. 2 shows a schematic cross-section of a quantum dot comprising different capping molecules. A quantum dot comprises a core 5 and several molecules linked to its surface. A quantum dot may comprise passivating molecules 9 and capping molecules with functional unit. A capping molecule with functional unit may comprise an electron transport moiety 6, a hole transport moiety 7 or an exciton transport moiety 8 as functional unit. The capping molecules with functional units are linked to the surface of the quantum dot by coupling units 10. The passivating molecules 9 may also comprise a coupling unit 10. In some cases passivating molecules exhibit functional units which link the passivating molecules 9 to the surface of the quantum dots.

It is possible that a quantum dot comprises only one type of capping molecules with functional units such as only capping molecules with an electron transport moiety 6 or only capping molecules with a hole transport moiety 7 or only capping molecules with an exciton transport moiety 8. In addition, it is possible that a quantum dot comprises capping molecules with two or more different types of functional units. It is also possible that a quantum dot comprises only a single capping molecule with functional unit. In addition, it is also possible that two or more quantum dots are coupled to the same capping molecule with functional unit, e. g. if the functional unit is a polymer.

Hole processing means 2 and electron processing means 4 are connected with power supply contacts and the whole electroluminescent device is connected to an external power source. When a voltage is provided between the power supply contacts, electrons and holes are injected and transported toward light emitting layer 3. With the help of a capping molecule with an electron transporting moiety 6 as functional unit, and said capping molecule with functional unit being linked to the surface of the quantum dot, an electron is transported to the core 5 of the quantum dot. When a hole is transported to the core 5 of the quantum dot, for example by a hole transporting moiety 7 which is also linked to the surface of the quantum dot, recombination occurs and light, most likely visible light, is emitted. Another possibility is that in light emitting layer 3 a hole and an electron form an exciton (electron-hole-pair). The exciton, which transports energy but no charge, is transported to the core 5 of the quantum dot by an exciton transporting moiety 8. Finally the energy of the exciton is released by recombination of the electron and the hole.

The invention is described with reference to the following example, which is presented for the purpose of illustration and which is not intended to be limiting of the invention.

### EXAMPLE 1

A glass plate serving as substrate 1 was covered with indium tin oxide serving as hole processing means 2. The hole processing means was covered with light emitting layer 3 which comprises quantum dots embedded in a ZnS layer. Each quantum dot comprises a core 5 made of InGaP and several different molecules on the surface of the quantum dot. As passivating molecules 9, fluoride ions are linked to surface of the quantum dot by treating the quantum dot with diluted hydrofluoric acid. A first set of capping molecules with functional units comprising a thiol unit serving as coupling unit 10 and a triphenyl amine unit serving electron transport moiety 6 is linked to the surface the quantum dot. A n-octyl unit serves as spacer unit and connects one phenyl ring of the electron transport moiety 6 with coupling unit 10. In addition a second set of capping molecules with functional units comprising a thiol unit serving as coupling unit 10 and a 2,2′:5′,2″:5″,2′″:5′″,2″″-quinque thiophene unit serving as hole transport moiety 7 is linked to the surface of the quantum dot. A n-hexyl unit serves as spacer unit and connects the quinque thiophene in 5-position with coupling unit 10. In addition, a third set of capping molecules with functional units comprising a thiol unit serving as coupling unit 10 and a phenoxazone unit serving as exciton transport moiety 8 is linked to the surface of the quantum dot. A n-butyl unit serves as spacer unit and connects the phenoxazone unit with the coupling unit 10. On top of light emitting layer 3, an electron processing means 4 was deposited. The electron processing means 4 consists of Al. The whole device was sealed with an epoxy resin. Hole processing means 2 and electron processing means 4 were connected with power supply contacts and the whole electroluminescent device was connected to an external power source. The whole device shows an improved electroluminescent quantum yield.

1. An electroluminescent device comprising:
a) hole processing means (2) capable of injecting and transporting holes;
b) a light emitting layer (3) in contact with said hole processing means (2), comprising quantum dots; each of said quantum dots being provided with at least one capping molecule with functional unit on the quantum dot surface which causes excited state injection into the quantum dot; and
c) electron processing means (4) in contact with said light emitting layer (3) for injecting and transporting electrons into said light emitting layer (3).

2. The electroluminescent device of claim 1, wherein said excited state comprises a hole, an electron or an exciton.

3. The electroluminescent device of claim 1, wherein said capping molecule with functional unit comprises as functional unit an electron transport moiety (6), a hole transport moiety (7) or an exciton transport moiety (8).

4. The electroluminescent device of claim 3, wherein said electron transport moiety (6) is selected from the group of oxadiazoles, oxadiazole derivatives, oxazoles, oxazole derivatives, isoxazoles, isoxazole derivatives, thiazoles, thiazole derivatives, isothiazoles, isothiazole derivatives, thiadiazoles, thiadiazole derivatives, 1,2,3 triazoles, 1,2,3 triazole derivatives, 1,3,5 triazines, 1,3,5 triazine derivatives, quinoxalines, quinoxaline derivatives, pyrrol oligomers, pyrrol polymers, phenylenevinylene oligomers, phenylenevinylene polymers, vinylcarbazol oligomers, vinylcarbazol polymers, fluorene oligomers, fluorene polymers, phenylenethyne oligomers, phenylenethyne polymers, phenylene oligomers, phenylene polymers, thiophene oligomers, thiophene polymers, acetylene polymers and acetylene oligomers.

5. The electroluminescent device of claim 3, wherein said hole transport moiety (7) is selected from the group consisting of tertiary aromatic amines, thiophene oligomers, thiophene polymers, pyrrol oligomers, pyrrol polymers, phenylenevinylene oligomers, phenylenevinylene polymers, vinylcarbazol oligomers, vinylcarbazol polymers, fluorene oligomers, fluorene polymers, phenylenethyne oligomers, phenylenethyne polymers, phenylene oligomers, phenylene polymers, acetylene oligomers, acetylene polymers, phthalocyanines, phthalocyanine derivatives, porphyrine and porphyrine derivatives.

6. The electroluminescent device of claim 3, wherein said exciton transport moiety (8) is selected from the group consisting of fluorene oligomers, fluorene polymers, phenylenevinylene oligomers, phenylenevinylene polymers, perylenes, perylene derivatives, coumarines, coumarine derivatives, phenoxazones, phenoxazone derivatives, 9,9′ spirobifluorene oligomers, 9,9′ spirobifluorene polymers, phenylene polymers, phenylene oligomers, 4-dicyanmethylene-2-methl-6-(p-dimethylaminostyryl)-4H-pyran (DCM), 4-dicyanmethylene-2-methyl-6-(p-dimethylaminostyryl)-4H-pyran derivatives, rhodamine, rhodamine derivatives, oxazines, oxazine derivatives, oxazole, oxazole derivatives, styryls, styryl derivatives, metal-organic complexes, stilbenes, stilbene derivatives, flavins, flavin derivatives, fluorescein, fluorescein derivatives, pyrromethenes and pyrromethene derivatives.

7. The electroluminescent device of claim 1, wherein said capping molecule with functional unit is linked to the surface of the quantum dot via a coupling unit (10) selected from the group consisting of thiols, sulfates, sulfites, sulfides, carboxylic acids, aldehydes, alcohols, esters, phosphines, phosphates, amines and non-fused polynuclear pyridines.

8. The electroluminescent device of claim 1, wherein said quantum dot is further provided with at least one passivating molecule on its surface.

9. The electroluminescent device of claim 8, wherein said passivating molecule is selected from the group consisting of fluoride ions, molecules comprising a non-aromatic hydrocarbon moiety, coordinating solvents, phosphanes and phosphane oxides.

10. Quantum dot provided with at least one capping molecule with functional unit on the quantum dot surface which causes excited state injection into the quantum dot.
